(19) United States
(12) Patent Application Publication
(10) Pub. No.: US 2015/0026408 A1
(43) Pub. Date: Jan. 22, 2015

(54) CACHE MEMORY SYSTEM AND METHOD OF OPERATING THE SAME

(71) Applicants: KONGJU NATIONAL UNIVERSITY INDUSTRY-UNIVERSITY COOPERATION FOUNDATION, Chungcheongnam-do (KR); SAMSUNG ELECTRONICS CO., LTD., Suwon-si (KR)

(72) Inventors: Won-jong LEE, Seoul (KR); Young-sam SHIN, Hwaseong-si (KR); Hyun-sang PARK, Chungcheongnam-do (KR)

(73) Assignees: KONGJU NATIONAL UNIVERSITY INDUSTRY-UNIVERSITY COOPERATION FOUNDATION, Chungcheongnam-do (KR); SAMSUNG ELECTRONICS CO., LTD., Suwon-si (KR)

(21) Appl. No.: 14/227,484

(22) Filed: Mar. 27, 2014

(30) Foreign Application Priority Data
Jul. 17, 2013 (KR) 10-2013-0084380

(51) Int. Cl. G06F 12/08

(52) U.S. Cl. CPC G06F 12/0804; G06F 12/0891; G06F 2212/604
USPC 711/133

(57) ABSTRACT

A cache memory system and a method of operating the cache memory system are provided. The cache memory system includes: an address buffer for receiving address bits including a cache address and a tag address from the outside or externally; a cache memory including a memory array, the cache memory outputting, from a row of the memory array which the cache address designates, a plurality of pieces of tag data and a plurality of pieces of cache data corresponding to the plurality of pieces of tag data; and a register configured to temporarily store a data set including the plurality of pieces of cache data output from the cache memory.

### CROSS-REFERENCE TO RELATED APPLICATIONS

This application claims the benefit of Korean Patent Application No. 10-2013-0084380, filed on Jul. 17, 2013, in the Korean Intellectual Property Office, the disclosure of which is incorporated herein in its entirety by reference.

### BACKGROUND

1. Field

The present disclosure relates to cache memory systems and methods of operating the cache memory systems and, more particularly, to cache memory systems for reducing power consumption and methods of operating the cache memory systems.

2. Description of the Related Art

In general, a processing device, such as a central processing unit (CPU), receives a command or data stored in a high capacity external memory and processes the received command or data. Processing speeds of most of high capacity external memories are very slow compared to that of the CPU, and thus, a cache memory system is used to improve an operating speed.

To improve data transmission speed, the cache memory system stores data recently accessed by the CPU and allows the CPU to access a high speed cache memory without accessing an external memory when the CPU requires the same data again.

When data requested by the CPU has been stored in the cache memory (cache hit), the data of the cache memory is delivered to the CPU. On the other hand, when data requested by the CPU is not in the cache memory (cache miss), data of the external memory is delivered to the CPU.

Such a cache memory may be implemented by a set associative cache memory using a set associative mapping method or a direct mapped cache memory using a direct mapping method, according to a mapping method. A set associative cache memory of which number of sets (i.e., set size) is 1 may be referred to as a direct mapped cache memory. The direct mapped cache memory indicating a set associative cache memory of which set size is 1 has the simplest cache memory structure.

In order to increase a cache hit, the set size (i.e., the number of sets) of the set associative cache memory may be increased to obtain more data storage area. However, in this case, the number of memory devices increases, and thus, the implementation cost and power consumption increase too.

### SUMMARY

Provided are cache memory systems for reducing implementation cost thereof and reducing power consumption.

Provided are methods of operating the cache memory systems.

Additional aspects will be set forth in part in the description which follows and, in part, will be apparent from the description, or may be learned by practice of the presented embodiments.

According to an aspect of the embodiments, a cache memory system includes an address buffer for receiving address bits including a cache address and a tag address from the outside or externally; a cache memory including a memory array, the cache memory outputting, from a row of the memory array which the cache address designates, a plurality of pieces of tag data and a plurality of pieces of cache data respectively corresponding to the plurality of pieces of tag data; a register configured to temporarily store a data set including the plurality of pieces of cache data output from the cache memory; and a controller configured to compare the tag address of the address buffer with the plurality of pieces of tag data and to receive new data from a region of a main memory which the tag address designates, according to the comparison result, wherein the controller replaces any one of the temporarily stored plurality of pieces of cache data with the new data to update the data set. According to another aspect of the embodiments, a method of operating a cache memory system includes receiving address bits including a cache address and a tag address from the outside; outputting, from a row of a memory array which the cache address designates, a plurality of pieces of tag data and a plurality of pieces of cache data corresponding to the plurality of pieces of tag data; comparing the tag address with the output plurality of pieces of tag data; temporarily storing a data set including the output plurality of pieces of cache data; receiving new data from a region of a main memory which the tag address designates, according to the comparison result; and replacing any one of the temporarily stored plurality of pieces of cache data with the new data to update the data set.

According to another aspect of the embodiments, a cache memory system includes: an address buffer for receiving address bits including a cache address and a tag address from the outside; a cache memory including a memory array that includes a plurality of tag arrays for storing tag data and a plurality of cache arrays for storing cache data, wherein the tag arrays and the cache arrays are alternately arranged in a row direction of the memory array, and the cache memory simultaneously outputs a plurality of pieces of tag data and a plurality of pieces of cache data which are stored in one row, or simultaneously stores a plurality of pieces of tag data and a plurality of pieces of cache data in one row; a register configured to temporarily store a data set including the plurality of pieces of tag data and the plurality of pieces of cache data which are output from the one row of the cache memory; and a controller configured to compare a plurality of pieces of tag data stored in a row of the cache memory which the cache address designates with the tag address and to perform a cache hit operation or a cache miss operation according to the comparison result.

### BRIEF DESCRIPTION OF THE DRAWINGS

These and/or other aspects will become apparent and more readily appreciated from the following description of the embodiments, taken in conjunction with the accompanying drawings of which:

FIG. 1 is a block diagram for explaining a data processing system according to an embodiment;

FIG. 2 is a block diagram of a cache memory system according to an embodiment;

FIG. 3 is a diagram for explaining the cache memory system of FIG. 2;

FIG. 4 is a flowchart illustrating a method of operating a cache memory system, according to an embodiment;

FIG. 5 is a diagram for explaining an operating method when a cache hit occurs;

FIG. 6 is a diagram for explaining an operating method when a cache miss occurs;

FIG. 7 is a block diagram of an electronic system employing a cache memory system according to an embodiment;

FIG. 8 is a block diagram of a data processing apparatus employing a cache memory system according to an embodiment; and

FIG. 9 is a block diagram of a memory card employing a cache memory system according to an embodiment.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items.

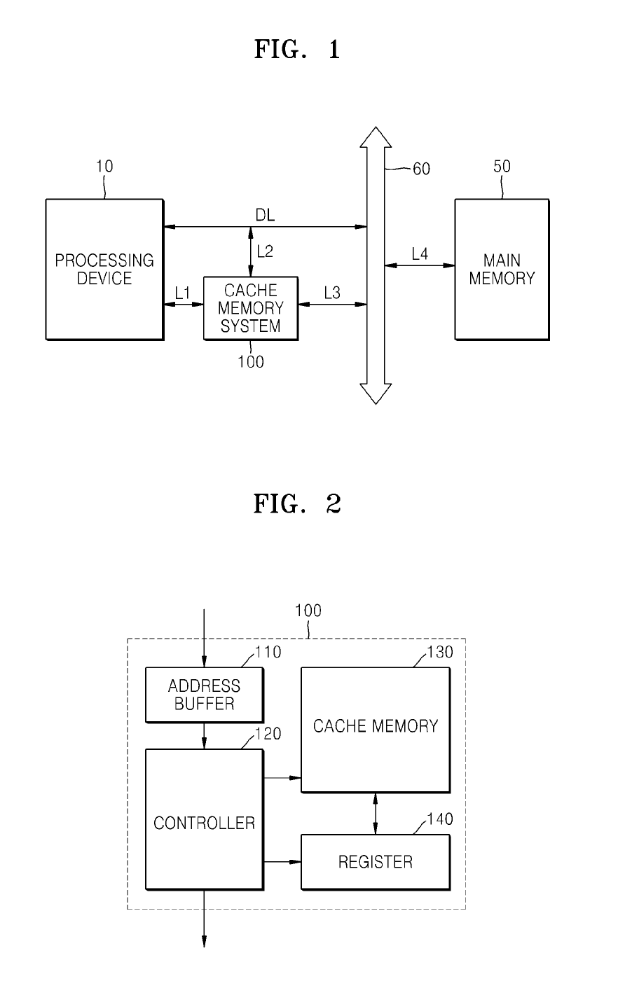

FIG. 1 is a block diagram for explaining a data processing system according to an embodiment.

Referring to FIG. 1, the data processing system may include a processing device 10 such as a central processing unit (CPU) or the like, a cache memory system 100, and a main memory 50. As shown in FIG. 2, the cache memory system 100 may include a cache memory 130 and a controller 120.

A line L3 of the cache memory system 100 and a data line DL of the processing device 10 may be connected to a system bus 60. A main memory controller (not shown) may be further included between the system bus 60 and the main memory 50, and may control the main memory 50 according to a control command of the processing device 10 or the cache memory system 100.

Although in FIG. 1, the cache memory system 100 and the processing device 10 are separated from each other for convenience of explanation, the embodiment is not limited thereto and the cache memory system 100 and the processing device 10 may be integrated in the same single chip.

During a data processing operation, the processing device 10 accesses the cache memory 130 before accessing the main memory 50. In this case, the processing device 10 applies address bits and a control command to the cache memory system 100 via a line L1.

When data or a command (hereinafter, referred to as target data) desired by the processing device 10 exists in the cache memory 130, an operation based on a cache hit is performed. During the cache hit, cache data (target data) output from the cache memory 130 is applied to the processing device 10 via a line L2 and the data line DL in turn.

The reason that the processing device 10 accesses the cache memory 130 rather the main memory 50 is because data of the main memory 50 that is frequently used may be stored in the cache memory 24 and thus data transmission speed may be improved by accessing the cache memory 130 rather than the main memory 50.

When the target data desired by the processing device 10 does not exist in the cache memory 130, an operation based on a cache miss is performed. In this case, the processing device 10 controls the main memory controller (not shown) via the system bus 60. Thus, the main memory 50 is accessed, and data output from the main memory 50 is applied to the data line DL via the system bus 60.

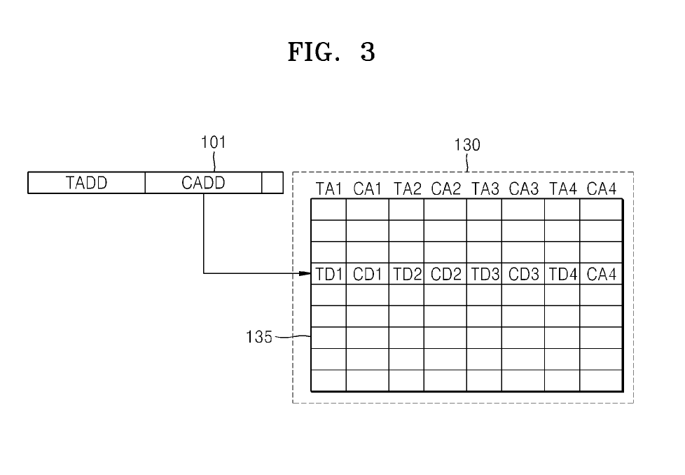

FIG. 2 is a block diagram of a cache memory system 100 according to an embodiment, and FIG. 3 is a diagram for explaining the cache memory system 100 according to the embodiment.

Referring to FIG. 2, the cache memory system 100 may include an address buffer 110, a cache memory 130, a register 140, and a controller 120. The cache memory 130 includes a memory array 135, and the memory array 135 stores cache data CD, which is the same as data stored in the main memory 50, and tag data TD indicating an actual address of the main memory 50 in which the data is stored. A structure of the main memory 50 is described in detail with reference to FIG. 3 below.

Referring to FIG. 3, the memory array 135 includes at least one row, and tag arrays TA for storing tag data and cache arrays CA for storing cache data are alternately arranged in a row direction. A plurality of pieces of tag data and a plurality of pieces of cache data corresponding thereto may be alternately stored in each row.

For example, when the cache memory 130 is configured by using a set associative cache memory having four sets as shown in FIG. 3, one tag array and one cache array constitute one set. Thus, the memory array 135 may include four tag arrays, i.e., first through fourth tag arrays TA1, TA2, TA3, and TA4, and four cache arrays corresponding to the four tag arrays, i.e., first through fourth cache arrays CA1, CA2, CA3, and CA4.

In conventional cache memory systems, a plurality of tag arrays and a plurality of cache arrays are implemented in respective memory devices. For example, the first through fourth tag arrays TA1, TA2, TA3, and TA4 are implemented in first through fourth memory devices, respectively, and the first through fourth cache arrays CA1, CA2, CA3, and CA4 are implemented in fifth through eighth memory devices, respectively. Thus, eight memory devices are used when configuring a cache memory system by using a set associative cache memory having four sets.

On the other hand, in the cache memory system 100 according to the embodiment, the memory array 135 including a plurality of tag arrays and a plurality of cache arrays is implemented in a single memory device as described above. Thus, the cache memory system 100 uses only one memory device.

Although in FIG. 3, the cache memory 130 is configured by using a set associative cache memory having four sets for convenience of explanation, the embodiment is not limited thereto and the cache memory 130 may be configured by using a set associative cache memory having N sets (where, N is 2n and n is an integer that is equal to or greater than 2). In this case, the memory array 135 may include N tag arrays and N cache arrays.

The number of rows of the memory array 135 may be determined according to the size of the cache memory 130, the number of sets, the size of tag data, and the size of cache data.

For example, when the cache memory system is configured by using a 4KB-4 set associative cache memory, the size of a piece of tag data is 6 bits, the size of a piece of cache data is 32 bits, and one row includes 152 bits (4*32+4*6) since the row includes four pieces of tag data and four pieces of cache data. Thus, the memory array 135 may include 256 rows.

The address buffer 110 may receive address bits 101 including a cache address CADD and a tag address TADD from an external system such as the processing device 10 of FIG. 1.

For example, the address bits 101 may include a cache address region including the cache address CADD and a tag address region including the tag address TADD, as shown in FIG. 3. The cache address CADD is data indicating a row address of the memory array 135, and the tag address TADD is data indicating an actual address of the main memory 50 in which target data requested by the processing device 10 is stored.

Thus, the size of the cache address region is determined according to the number of rows of the cache memory 130, and the size of the tag address region is determined according to the size of an address of the main memory 50.

For example, as described above, when the number of rows of the cache memory 130 is 256, the size of the cache address region may be 8 bits. When the size of the tag data is 6 bits, the size of the tag address region may also be 6 bits.

Referring back to FIG. 2, the controller 120 determines whether target data is stored in the cache memory 130, that is, a cache hit or a cache miss occurs, based on the address bits 101, and performs a cache hit operation or a cache miss operation based on the determination result.

In detail, the controller 120 compares a plurality of pieces of tag data stored in a row of the cache memory 130, which the cache address CADD designates, with the tag address TADD to determine whether a cache hit or a cache miss occurs.

For example, as shown in FIG. 3, the controller 120 compares each of a plurality of pieces of tag data TD1, TD2, TD3, and TD4 stored in a row of the cache memory 130, which the cache address CADD designates, with the tag address TADD to determine whether each of the tag data TD1, TD2, TD3, and TD4 is matched with the tag address TADD.

The cache hit occurs when the tag address TADD is matched with any one of a plurality of pieces of tag data stored in a row of the cache memory 130 which the cache address CADD designates, and indicates that target data requested by the processing device 10 exists in a row of the cache memory 130 which the cache address CADD designates.

The cache miss occurs when the tag address TADD is not matched with a plurality of pieces of tag data stored in a row of the cache memory 130 which the cache address CADD designates, and indicates that target data requested by the processing device 10 does not exist in a row of the cache memory 130 which the cache address CADD designates.

The register 140 may temporarily store a data set including a plurality of pieces of tag data and a plurality of pieces of cache data, which are stored in any row of the memory array 135.

Particularly, when it is determined that a cache miss occurs, the controller 120 controls the register 140 so as to temporarily store a data set in the register 140, the data set including a plurality of pieces of tag data and a plurality of pieces of cache data which are stored in a row of the cache memory 130 which the cache address CADD designates.

When the memory array 135 is configured as described above, the register 140 may include 152 bits to store a data set including four pieces of tag data and four pieces of cache data which constitute one row of the memory array 135.

Each component of the cache memory system 100 illustrated in FIG. 2 may be combined with another component or omitted according to a specification of the cache memory system 100. In addition, an additional component may be added to the cache memory system 100. That is, if necessary, two or more components may be combined in a single component, and a single component may be divided into two or more components. In addition, a function that is performed in each component is for explaining the embodiments, and does not limit the scope of the embodiments.

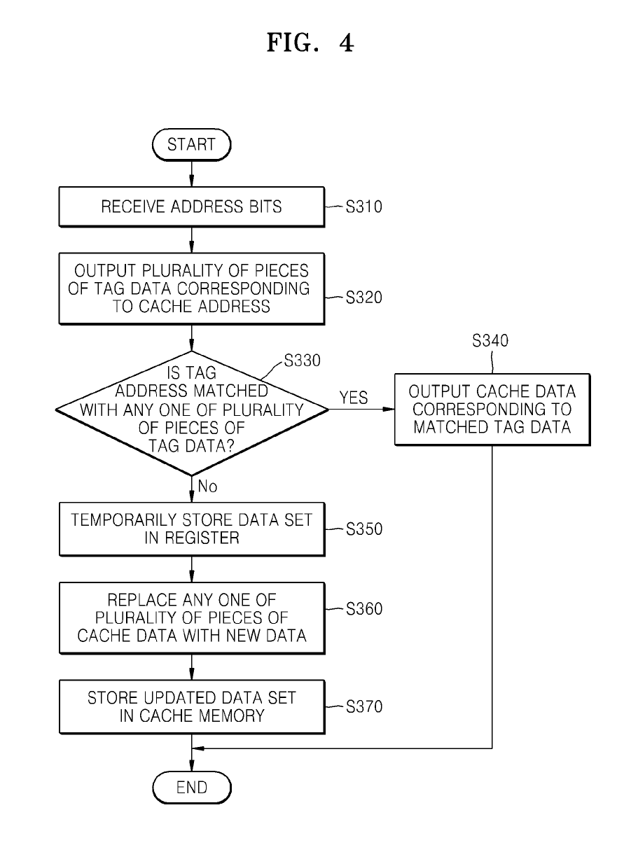

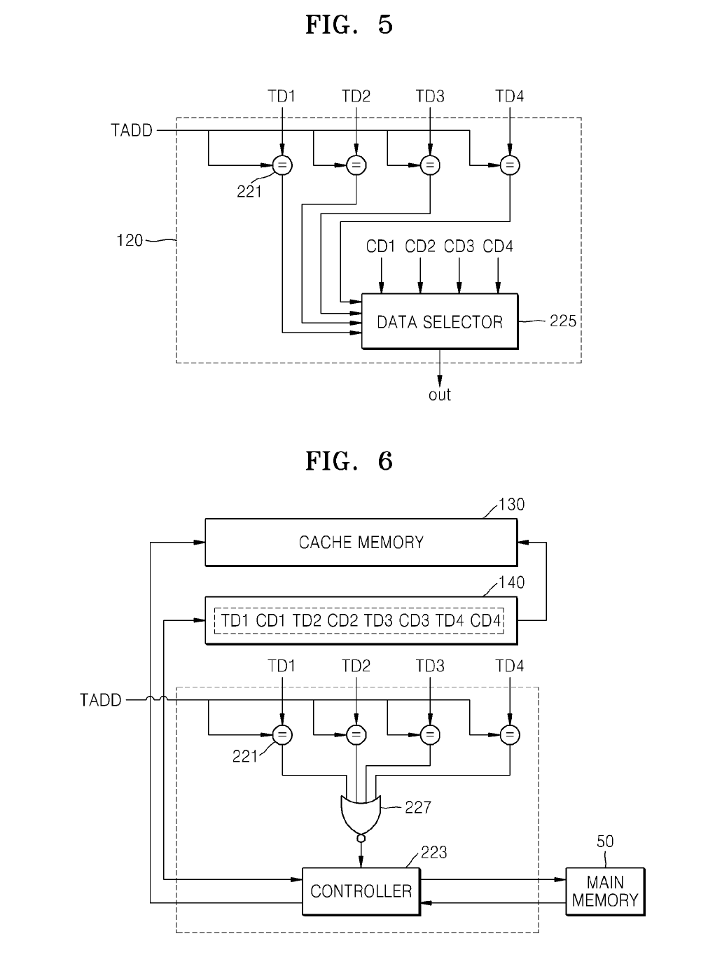

FIG. 4 is a flowchart illustrating a method of operating a cache memory system, according to an embodiment, FIG. 5 is a diagram for explaining an operating method when a cache hit occurs, and FIG. 6 is a diagram for explaining an operating method when a cache miss occurs.

Referring to FIG. 4, the address buffer 110 receives address bits 101 including a cache address CADD and a tag address TADD from the processing device 10 (operation S310).

When the address bits 101 are received, the controller 120 controls the cache memory 130 so as to output a plurality of pieces of tag data stored in a row of the cache memory 130 which the cache address CADD designates (operation S320).

For example, as shown in FIG. 3, when the controller 120 applies the cache address CADD received from the address buffer 110 to the cache memory 130, the cache address CADD is applied to the first through fourth tag arrays TA1, TA2, TA3, and TA4 of the cache memory 130 via a line (not shown).

The first through fourth tag arrays TA1, TA2, TA3, and TA4 output first through fourth tag data TD1, TD2, TD3, and TD4 in response to the cache address CADD to comparators 221 via lines, as shown in FIGS. 5 and 6.

The controller 120 applies the tag address TADD received from the address buffer 110 to each of the comparators 221. The comparators 221 compare the tag address TADD with the first through fourth tag data TD1, TD2, TD3, and TD4 to determine whether the tag address TADD is matched with any one of the first through fourth tag data TD1, TD2, TD3, and TD4 (operation S330).

When the tag address TADD is matched with any one of the first through fourth tag data TD1, TD2, TD3, and TD4 (that is, when a cache hit occurs), a data selector 225 selects cache data corresponding to the matched tag data as shown in FIG. 5, and outputs the selected cache data to the processing device 10 (operation S340).

On the other hand, when the tag address TADD is not matched with the first through fourth tag data TD1, TD2, TD3, and TD4 (that is, when a cache miss occurs), the controller 120 performs a cache miss operation.

The controller 120 may include a NOR circuit 227 as shown in FIG. 6 and may generate a cache miss signal. For example, output data of each of the comparators 221 is applied to each input line of the NOR circuit 227, the comparators 221 each output “0” as an output data value when the tag address TADD is not matched with the first through fourth tag data TD1, TD2, TD3, and TD4, and the NOR circuit 227 outputs “0” as an output data value to generate the cache miss signal when inputs of the NOR circuit 227 are all “0” (that is, when a cache miss occurs).

When the controller 223 receives the cache miss signal, the controller 223 controls the register 140 so as to temporarily store in the register 140 (operation S350) a data set including a plurality of pieces of tag data TD1, TD2, TD3, and TD4 and a plurality of pieces of cache data CD1, CD2, CD3, and CD4 which are stored in a row of the cache memory 130 which the cache address CADD designates.

The controller 223 may request the main controller (not shown) to output new data corresponding to the tag address TADD stored in the main memory 50.

The main controller may control the main memory 50 so that new data stored in a region of the main memory 50 which the tag address TADD designates may be output. Thus, the new data output from the main memory 50 may be applied to the data line DL via the system bus 60 of FIG. 1, and may be transmitted to the cache memory system 100 and the processing device 10.

To update the data set, the controller 223 may receive the new data, may replace any one of the plurality of pieces of cache data CD1, CD2, CD3, and CD4 temporarily stored in the register 140 with the new data, and may replace tag data corresponding to cache data replaced with the new data with data that is the same as the tag address TADD (operation S360).

The controller 223 controls the memory array 135 to store the updated data set in a row of the memory array 135 which the cache address CADD designates (operation S370).

Thus, when a cache miss occurs, the controller 120 may perform a write operation for the new data with respect to each row of the cache memory 130, as described above.

Table 1 indicates the number of equivalent gates of memory devices constituting a conventional 4KB-4 set associative cache memory system and the amount of power that is consumed during a read operation or a write operation of the conventional associative cache memory system.

Table 2 indicates the number of equivalent gates of a 4KB-4 set associative cache memory system using a single memory device like in the embodiments and the amount of power that is consumed during a read operation or a write operation of the 4KB-4 set associative cache memory system using a single memory device.

The read operation is an operation of outputting data of a cache memory, and the write operation is as an operation of storing data into the cache memory.

TABLE 1

| | | Read Power | Write Power |
|---|---|---|---|
| Device | The number of gates | [uW/MHz] | [uW/MHz] |
| Four 256 × 6 | 65.26 | 102.4 | 24.21 |
| Four 256 × 32 | | | |

TABLE 2

| | | Read Power | Write Power |
|---|---|---|---|
| Device | The number of gates | [uW/MHz] | [uW/MHz] |
| Single 256 × 152 | 47.76 | 78.03 | 99.90 |

Referring to Table 1, the conventional cache memory system is configured with eight memory devices since a plurality of tag arrays and a plurality of cache arrays are implemented with respective memory devices. On the other hand, referring to Table 2, the cache memory system according to the embodiment is configured with a single memory device since a plurality of tag arrays and a plurality of cache arrays are implemented with a single memory device.

Thus, since in the cache memory system according to the embodiment, a plurality of tag arrays and a plurality of cache arrays are integrated in a single memory device, the number of equivalent gates is reduced by about 26.8% compared to the conventional cache memory system.

Referring to Table 1, since a write operation is performed on only a memory device corresponding to data to be written, a data width that is necessary for a write operation is smaller than a data width that is necessary for a read operation, and thus, the amount of power that is consumed in the write operation is smaller than the amount of power that is consumed in the read operation.

Referring to Tables 1 and 2, since the cache memory system according to the embodiment performs the write operation with respect to only a single memory device, the amount of power that is consumed in the write operation is decreased compared to the conventional cache memory system that performs the write operation with respect to multiple memory devices.

On the contrary, since the cache memory system according to the embodiment has to perform the write operation for each row of the main memory 50 unlike the conventional cache memory system, a data width that is necessary for the write operation of the cache memory system according to the embodiment is larger than that that is necessary for the write operation of the conventional cache memory system, and thus, the amount of power that is consumed in the write operation of the cache memory system according to the embodiment is about four times the amount of power that is consumed in the write operation of the conventional cache memory system.

However, since a write operation to a cache memory system is performed only when a cache miss occurs, an average power consumption has to be calculated considering that the incidence of cache miss is less than 10%.

In this regard, when the incidence of cache miss is less than 10%, an average power consumption of the conventional cache memory system is about 104.52 (i.e., 102.4+24.21×0.1) uW/MHz, and an average power consumption of the cache memory system according to the embodiment is about 88.02 (i.e., 8.03+99.9×0.1) uW/MHz.

Thus, the average power consumption of the cache memory system according to the embodiment is reduced by about 15.8% compared to the conventional cache memory system.

As described above, the cache memory system according to the embodiment may effectively reduce the power consumption and implementation cost thereof while performing the same operation as the conventional cache memory system.

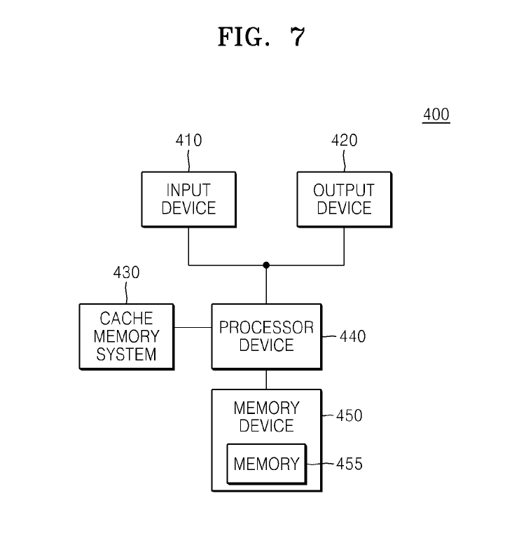

FIG. 7 is a block diagram of an electronic system 400 employing a cache memory system according to an embodiment. Referring to FIG. 7, the electronic system 400 includes an input device 410, an output device 420, a processor device 440, a cache memory system 430, and a memory device 450. The cache memory system 430 corresponds to the cache memory system 100 according to the embodiment.

The memory device 450 may include a general dynamic random access memory (DRAM). The processor device 440 controls the input device 410, the output device 420, and the memory device 450 via corresponding interfaces. In FIG. 7, when the cache memory system 100 described with reference to FIGS. 2 through 6 is employed as the cache memory system 430 of the electronic system 400, the power consumption and implementation cost of the cache memory system 430 may be reduced.

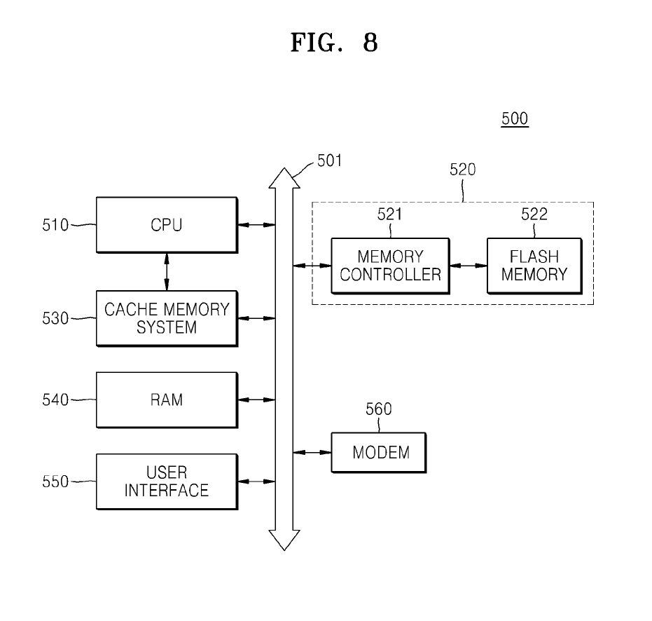

FIG. 8 is a block diagram of a data processing apparatus 500 employing a cache memory system according to an embodiment.

Referring to FIG. 8, a cache memory system 530 corresponding to the cache memory system 100 according to the embodiment may be mounted in the data processing apparatus 500, such as a mobile terminal or a desktop computer. The data processing apparatus 500 may include a flash memory system 520, a modem 560, a CPU 510, a cache memory system 530, a random access memory (RAM) 540, and a user interface 550, which are connected to each other via a system bus 501. The flash memory system 520 may have substantially the same configuration as a general memory system, and may include a memory controller 521 and a flash memory 522. Data processed by the CPU 520 or data input from the outside (externally) may be stored in a non-volatile state in the flash memory system 510. The flash memory system 520 may be implemented as a solid state disk (SSD), and in this case, an information processing system may stably store high-volume data in the flash memory system 520. According to the increase of reliability, the flash memory system may reduce resources that are used in error correction, and thus, may provide a high-speed data exchange function to the data processing apparatus 500. Although not illustrated in FIG. 8, the data processing apparatus 500 may further include an application chipset, a camera image processor (CIS), an input/output device, etc.

The cache memory system 530 or the flash memory system 520 may be mounted by using any of various types of packages. For example, the cache memory system 530 or the flash memory system 520 may be packaged by using a method such as a package on package (PoP), a ball grid array (BGA), a chip scale package (CSP), a plastic leaded chip carrier (PLCC), a plastic dual in-line package (PDIP), a die in waffle pack, a die in wafer form, a chip on board (COB), a ceramic dual in-line package (CERDIP), a plastic metric quad flat pack (MQFP), a thin quad flat pack (TQFP), a small outline (SOIC), a shrink small outline package (SSOP), a thin small outline (TSOP), a thin quad flat pack (TQFP), a system in package (SIP), a multi chip package (MCP), a wafer-level fabricated package (WFP), a wafer-level processed stack package (WSP), or the like.

In FIG. 8, when the cache memory system 100 described with reference to FIGS. 2 through 6 is employed as the cache memory system 530 of the data processing apparatus 500, the power consumption and implementation cost of the cache memory system 530 may be reduced.

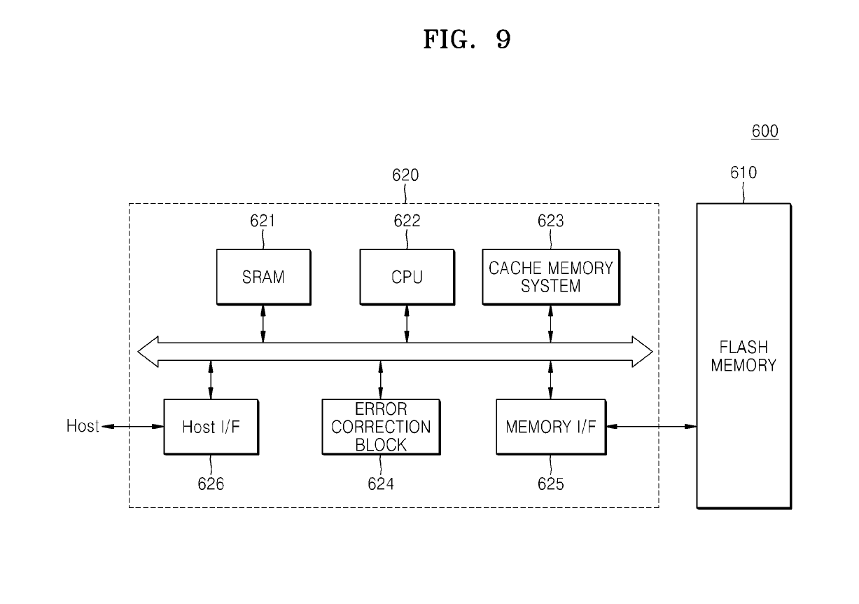

FIG. 9 is a block diagram of a memory card 600 employing a cache memory system according to an embodiment.

Referring to FIG. 9, the memory card 600 for supporting high data storage capacity includes a cache memory system 623 corresponding to the cache memory system 100 according to the embodiment. The memory card 600 includes a memory controller 620 for controlling a data exchange between a host HOST and a flash memory 610.

In the memory controller 620, a static random access memory (SRAM) 621 is used as an operating memory of a CPU 622.

A host interface 626 functions as a data exchange interface between the memory card 600 and the host HOST. An error correction block 624 detects and corrects an error included in data read from the flash memory 610. A memory interface 625 functions as a data interface between the CPU 622 and the flash memory 610. The CPU 622 controls an operation related to a data exchange of the memory controller 620. Although not illustrated in FIG. 9, the memory card 600 employing the cache memory system 623 corresponding to the cache memory system 100 according to the embodiment may further include a read only memory (ROM) (not shown) that stores code data for interfacing with the host HOST.

In FIG. 9, when the cache memory system 623 in the memory card 600 is the same as the cache memory system 100 described with reference to FIGS. 2 through 6 , the power consumption and implementation cost of the cache memory system 623 may be reduced. Thus, the performance and reliability of the memory card 600 employing the cache memory system 623 may be improved.

The cache memory system according to the embodiment and the method of operating the cache memory system according to the embodiment are not limited to the exemplary embodiments set forth herein, and may be embodied in many different forms.

As described above, according to the one or more of the above embodiments, the implementation cost and power consumption of a cache memory system may be reduced by implementing a plurality of tag arrays and a plurality of cache arrays of a set associative cache memory in a single memory device.

In addition, other embodiments can also be implemented through computer readable codes/instructions in/on a medium, e.g., a computer readable medium, to control at least one processing element to implement any above described embodiment. The medium can correspond to any medium/media permitting the storage and/or transmission of the computer readable code.

The computer readable codes can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as Internet transmission media. Thus, the medium may be such a defined and measurable structure including or carrying a signal or information, such as a device carrying a bitstream according to one or more embodiments. The media may also be a distributed network, so that the computer readable code is stored/transferred and executed in a distributed fashion. Furthermore, the processing element could include a processor or a computer processor, and processing elements may be distributed and/or included in a single device.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A cache memory system, comprising:
an address buffer for externally receiving address bits including a cache address and a tag address;
a cache memory comprising a memory array, the cache memory outputting, from a row of the memory array which the cache address designates, a plurality of pieces of tag data and a plurality of pieces of cache data respectively corresponding to the plurality of pieces of tag data;
a register configured to temporarily store a data set comprising the plurality of pieces of cache data output from the cache memory; and
a controller configured to compare the tag address of the address buffer with the plurality of pieces of tag data to produce a comparison result and to receive new data from a region of a main memory which the tag address designates, according to the comparison result,
wherein the controller replaces any one of the temporarily stored plurality of pieces of cache data with the new data to update the data set to produce an updated data set.

2. The cache memory system of claim 1, wherein the controller stores the updated data set in the row of the memory array which the cache address designates.

3. The cache memory system of claim 1, wherein when the tag address of the address buffer matches any one of the plurality of pieces of tag data as the comparison result, the controller determines that a cache hit occurs and selects cache data corresponding to the matched tag data and externally transmits the selected cache data.

4. The cache memory system of claim 1, wherein when the tag address of the address buffer does not match any one of the plurality of pieces of tag data as the comparison result, the controller determines that a cache miss occurs and transmits a signal requesting the new data to the main memory.

5. The cache memory system of claim 1, wherein the controller receives the new data and externally transmits the received new data.

6. The cache memory system of claim 1, wherein the memory array comprises:
first through N-th tag arrays for storing the plurality of pieces of tag data, wherein, N is 2′ and n is an integer that is equal to or greater than 1; and first through N-th cache arrays for storing the plurality of pieces of cache data, wherein the tag arrays and the cache arrays are alternately arranged in a row direction.

7. The cache memory system of claim 1, wherein the data set temporarily stored in the register further comprises the plurality of pieces of tag data corresponding to the plurality of pieces of cache data, and the controller replaces tag data corresponding to cache data replaced with the new data with the tag address of the address buffer to update the data set.

8. The cache memory system of claim 1, wherein the tag address and the plurality of pieces of tag data indicate an actual address of the main memory.

9. The cache memory system of claim 1, wherein only when the tag address of the address buffer does not match any one of the plurality of pieces of tag data as the comparison result, the controller controls the register to temporarily store the data set in the register.

10. A method of operating a cache memory system, the method comprising:
receiving, externally, address bits including a cache address and a tag address;
outputting, from a row of a memory array which the cache address designates, a plurality of pieces of tag data as output plurality of pieces of tag data and a plurality of pieces of cache data corresponding to the plurality of pieces of tag data;
comparing the tag address with the output plurality of pieces of tag data to produce a comparison result;
temporarily storing a data set comprising the output plurality of pieces of cache data;
receiving new data from a region of a main memory which the tag address designates, according to the comparison result; and
replacing any one of the temporarily stored plurality of pieces of cache data with the new data to update the data set to produce an updated data set.

11. The method of claim 10, further comprising storing the updated data set in the row of the memory array which the cache address designates.

12. The method of claim 10, further comprising: when the tag address of the address buffer matches any one of the plurality of pieces of tag data as the comparison result, determining that a cache hit occurs and selecting cache data corresponding to the matched tag data and externally transmitting the selected cache data.

13. The method of claim 10, further comprising: when the tag address of the address buffer does not match any one of the plurality of pieces of tag data as the comparison result, determining that a cache miss occurs and transmitting a signal requesting the new data to the main memory.

14. The method of claim 10, further comprising receiving the new data and externally transmitting the received new data.

15. The method of claim 10, further comprising replacing tag data corresponding to cache data replaced with the new data with the tag address to update the data set,
wherein the data set further comprises the plurality of pieces of tag data corresponding to the plurality of pieces of cache data.

16. A cache memory system, comprising:
an address buffer for externally receiving address bits including a cache address and a tag address;
a cache memory comprising a memory array that comprises a plurality of tag arrays for storing tag data and a plurality of cache arrays for storing cache data, where the tag arrays and the cache arrays are alternately arranged in a row direction of the memory array, and the cache memory one of simultaneously outputs a plurality of pieces of tag data and a plurality of pieces of cache data which are stored in one row, and simultaneously stores a plurality of pieces of tag data and a plurality of pieces of cache data in one row;
a register configured to temporarily store a data set comprising the plurality of pieces of tag data and the plurality of pieces of cache data which are output from the one row of the cache memory; and
a controller configured to compare a plurality of pieces of tag data stored in an addressed row of the cache memory which the cache address designates with the tag address to produce a comparison result and to perform one of a cache hit operation and a cache miss operation according to the comparison result.

17. The cache memory system of claim 16, wherein when the tag address of the address buffer matches any one of the plurality of pieces of tag data as the comparison result, the controller determines that a cache hit occurs and selects cache data corresponding to the matched tag data and externally transmits the selected cache data.

18. The cache memory system of claim 16, wherein when the tag address of the address buffer does not match any one of the plurality of pieces of tag data as the comparison result, the controller determines that a cache miss occurs and receives new data from a region of a main memory which the tag address designates.

19. The cache memory system of claim 18, wherein the controller replaces any one of the temporarily stored plurality of pieces of cache data with the new data to update the data set.

20. The cache memory system of claim 19, wherein the controller stores the updated data set in a row of the main memory which the cache address designates.
